(19) United States
(12) Patent Application Publication
(10) Pub. No.: US 2024/0027096 A1
(43) Pub. Date: Jan. 25, 2024

(54) AIR CONDITIONER FRONT PANEL CONTROL METHOD AND FRONT PANEL APPARATUS

(71) Applicant: FOSHAN VIOMI ELECTRICAL TECHNOLOGY CO., LTD., Foshan (CN)

(72) Inventors: XIAO-PING CHEN, Foshan (CN); QING-SHENG TANG, Foshan (CN); YONG-CHIN LIM, Foshan (CN); WEI-JIAN CHEN, Foshan (CN)

(21) Appl. No.: 18/028,706

(22) PCT Filed: Jul. 2, 2021
(86) PCT No.: PCT/CN2021/104277

§ 371 Date: Mar. 27, 2023

(30) Foreign Application Priority Data
Sep. 25, 2020 (CN) 202011026071.0

(51) Int. Cl. F24F 13/12; F24F 1/0014

(52) U.S. Cl. CPC F24F 13/12; F24F 1/0014

(57) ABSTRACT

The present invention relates to the field of air conditioners, and in particular to an air conditioner front panel control method and a front panel apparatus. A first air outlet and a front panel movably provided on the front end face are provided on the front end face of an air conditioner; when moving forward and backward relative to the front end face, the front panel forms, with the front end face, an air outlet channel communicated with the first air outlet, and the air outlet channel forms at least one second air outlet at the peripheral edge of the front panel. The front panel control method comprises the steps of: controlling a front panel to move and adjusting a spatial position thereof, so as to control an air inlet volume of the air outlet channel.

### CROSS-REFERENCE TO RELATED APPLICATIONS

This application is an U.S. national phase application under 35 U.S.C. § 371 based upon international patent application No. PCT/CN2021/104277, filed on Jul. 2, 2021, which itself claims priority to Chinese patent application No. 2020110260710 filed on Sep. 25, 2020. The contents of the above identified applications are hereby incorporated herein in their entireties by reference.

### TECHNICAL FIELD

The present disclosure relates to the field of air conditioners, in particular to a method for controlling a front panel and a front panel device of an air conditioner.

### BACKGROUND

Air conditioner is a device that adjusts and controls the temperature, humidity, flow rate and other parameters of e ambient air in a building or structure by artificial means.

Generally, cold air or hot air is blown out of the air conditioner through an air outlet, and an air volume (a wind speed) is adjusted by an internal structure of the air conditioner to achieve an air volume adjustment, such as soft wind, small wind, normal wind, strong wind, etc. However, normal air conditioner needs to further adjust the air volume based on the soft wind (or the lowest wind speed), which can be achieved by designing a more precise and complex air volume adjustment structure. However, there are problems of high cost, easy damage and large power consumption.

Certainly, a front panel can also be provided at the air outlet of the air conditioner to divert the air blown out of the air outlet and reduce the air volume under a system resistance caused by the front panel, or the air is blown out in other directions (up, down, left, and right directions). However, the conventional front panel only has a conventional diversion adjustment function, which has a single function and a general experience, and cannot make good use of the function of the front panel for guiding and diverting air. For example, the front panel can only realize the opening and closing state to switch an air flow direction. However, the front panel can only switch the air flow direction, and cannot control the air volume.

### SUMMARY

The technical problem to be solved by the present disclosure is to provide a method for controlling front panel and a front panel device of an air conditioner in view of the above defects of the prior art, so as to solve the problem that the conventional front panel only has a conventional diversion adjustment function, which has a single function and a general experience, and cannot make good use of the function of the front panel for guiding and diverting air.

The technical solution adopted by the present disclosure to solve the technical problem is as follows. A method for controlling a front panel of an air conditioner is provided. A front end surface of the air conditioner is provided with a first air outlet and the front panel movably arranged on the front end surface, the front panel and the front end surface forms an air outlet channel in communication with the first air outlet when the front panel moves back and forth relative to the front end surface, and the air outlet channel forms at least one second air outlet at a peripheral edge of the front panel. The method for controlling the front panel of the air conditioner includes controlling a movement of the front panel and adjusting a spatial position of the front panel to control an air intake volume of the air outlet channel.

In a preferred solution, the front panel moves back and forth relative to the front end surface, and a spatial size of the air outlet channel is adjusted to control the air intake volume of the air outlet channel, the spatial size and the air intake volume of the air outlet channel have the same variation trend.

In a preferred solution, the front panel moves up and down relative to the front end surface, and an opening size of the first air outlet is adjusted to control the air intake volume of the air outlet channel, the opening size and the air intake volume of the air outlet channel have reverse variation trends.

In a preferred solution, the method for controlling the front panel further includes: configuring a first motion trajectory and a second motion trajectory, the first motion trajectory is a motion trajectory of the front panel moving back and forth relative to the front end surface, the second motion trajectory is a motion trajectory of the front panel moving up and down relative to the front end surface. The front panel moves on the front end surface according to the first motion trajectory and the second motion trajectory.

In a preferred solution, the first motion trajectory is an arc-shaped motion trajectory in a front-up direction, an oblique forward motion trajectory, or a horizontal forward motion trajectory.

In a preferred solution, the moving the front panel according to the first motion trajectory includes: moving the front panel back and forth, away from or adjacent to the front end surface; or ascending or descending the front panel during moving the front panel back and forth, so as to increase or decrease the opening size of the first air outlet.

In a preferred solution, the opening size of the first air outlet is not the maximum opening size when the front panel is located at the farthest stroke of the first motion trajectory, and the opening size of the first air outlet is the maximum opening size when the front panel is located at the highest stroke of the second motion trajectory.

In a preferred solution, the method for controlling the front panel further includes that configuring a closed state, a forward and backward movement state, and an up and down movement state; wherein the closed state is a state that the front panel is adjacent to the front end surface and closes or semi-closes the first air outlet or a front end of the first air outlet, the forward and backward movement state is a process that the front panel moves forward and backward relative to the front end surface, and the up and down movement state is a process that the front panel moves up and down relative to the front end surface; and controlling the front panel to be switched between the closed state and the forward and backward movement state, or controlling the front panel to be switched between the forward and backward movement state and the up and down movement state.

In a preferred solution, the second air outlet is an annular air outlet or a partial annular air outlet of the front panel, and air from the first air outlet is blocked by the front panel to enter the air outlet channel and is blown out of the second air outlet.

The technical solution adopted by the present disclosure to solve the technical problem is as follows. A front panel device of an air conditioner is provided. The front panel device includes an air conditioner body, a first air outlet provided on a front end surface of the air conditioner body, a front panel movably provided on the front end surface, and a driving mechanism provided between the front end surface and the front panel. The driving mechanism is fixed on the front end surface and is configured to drive the front panel to move according to the method for controlling the front panel.

In a preferred solution, the driving mechanism includes a lifting structure, a connecting rod and a track structure, one end of the connecting rod is connected to the lifting structure, a middle portion of the connecting rod is slidably connected to a track of the track structure, the other end of the connecting rod is connected to the front panel or is connected to the front panel through an intermediate element, the lifting structure is connected to the front end surface, and the connecting rod is driven by the lifting structure to drive the front panel to move along a trajectory of the track.

In a preferred solution, the track of the track structure is in a shape of a polyline.

Compared with the prior art, the beneficial effect of the present disclosure is that the front panel is movably provided on the front end surface, and the front panel can move forward and backward relative to the front end surface and the front panel moves up and down relative to the front end surface, so that the front panel can controls a wind speed, a change of an internal structure is reduced, the cost of research and development and product is reduced, and a controllability is high.

### BRIEF DESCRIPTION OF THE DRAWINGS

The present disclosure will be further described below with reference to the accompanying drawings and embodiments.

FIG. 1 is a structural schematic view of an air conditioner having a front panel according to the present disclosure.

FIG. 2 is a structural schematic view of the front panel of FIG. 1 away from a front end surface.

FIG. 3 is a structural schematic view of the front panel of FIG. 2 further away from the front end surface.

FIG. 4 is a front view of FIG. 2.

FIG. 5 is a structural schematic view of the front panel moving up and down relative to the front end surface according to the present disclosure.

FIG. 6 is a structural schematic view of the front panel of FIG. 5 lifted to the highest position.

FIG. 7 is a front view of FIG. 5.

FIG. 8 is a front view of FIG. 6.

FIG. 9 is a first structural schematic view of the air conditioner based on a first motion trajectory according to the present disclosure.

FIG. 10 is a first structural schematic view of the air conditioner based on a first motion trajectory and a second motion trajectory according to the present disclosure.

FIG. 11 is a second structural schematic view of the air conditioner based on a first motion trajectory according to the present disclosure.

FIG. 12 is a second structural schematic view of the air conditioner based on a first motion trajectory and a second motion trajectory according to the present disclosure.

FIG. 13 is a cross-sectional view of the air conditioner in a closed state according to the present disclosure.

FIG. 14 is a cross-sectional view of the air conditioner in a forward and backward movement state according to the present disclosure.

FIG. 15 is a cross-sectional view of the air conditioner in an up-and-down movement state according to the present disclosure.

FIG. 16 is a structural schematic view of a driving mechanism according to the present disclosure.

FIG. 17 is a cross-sectional view of the drive mechanism according to the present disclosure.

FIG. 18 is an exploded view of the driving mechanism according to the present disclosure.

### DETAILED DESCRIPTION OF THE EMBODIMENTS

The preferred embodiments of the present disclosure will be described in detail with reference to the accompanying drawings.

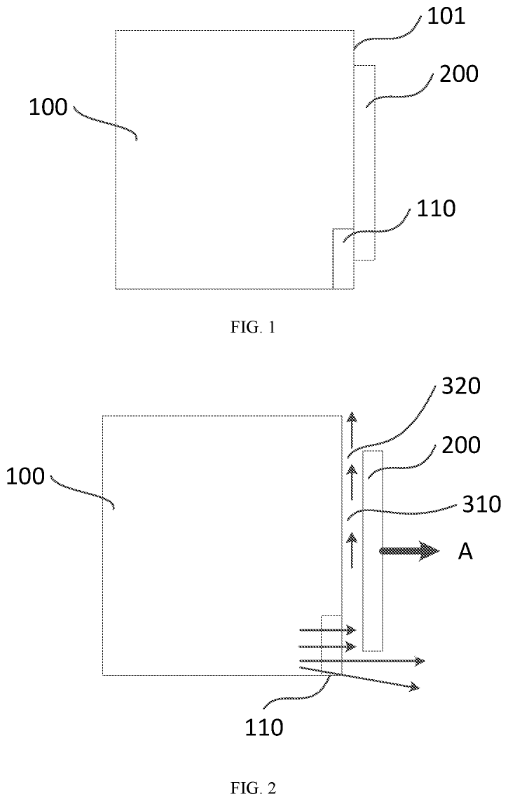

As shown in FIGS. 1 to 8, a front panel device and a front panel control method of an air conditioner are provided according to a preferred embodiment of the present disclosure.

Referring to FIG. 1, a front end surface 101 of the air conditioner is provided with a first air outlet 110 and a front panel 200 movably provided on the front end surface 101. The air conditioner includes a middle frame 100, the first air outlet 110 is an opening arranged on the middle frame 100 to blow air. The front panel 200 is movably arranged on the front end surface 101 of the middle frame 100 to form a system resistance for the air blown out of the first air outlet 110. Further, referring to FIG. 2 and FIG. 4, when the front panel 200 moves back and forth relative to the front end surface 101, that is, the front panel 200 moves away from or close to the front end surface 101, such as moving forward along a direction A, the front panel 200 and the front end surface 101 form an air outlet channel 310 in communication with the first air outlet 110. That is, a gap is formed between the front panel 200 and the front end surface 101. In addition, the air outlet channel 310 forms at least one second air outlet 320 at a peripheral edge of the front panel 200. That is, at an edge opening of the gap, the air blown out of the first air outlet 110 is partially blocked by the front panel 200 and enters the air outlet channel 310, and then the air is directed to the second air outlet 320 to be blown out. Certainly, a directing structure may be provided in the air outlet channel 310 to direct a direction of the air, the air is blown out of the edge opening of the gap as the second air outlet 320, so that a volume of the air blown out of the first air outlet 110 is limited. Only a part of the air is blown out of a lower part of the front panel 200, so that a controllable soft wind state is achieved. A speed of air flow is controlled through the front panel 200, a change of the internal structure is reduced, the cost of research and development and product are reduced, and the controllability is high. A thin arrow indicates a direction of the air flow in principle, but an air outlet direction is influenced by a protruding edge of the middle frame 100 and an air deflector to have a forward direction, for example, the air is blown out in a forward direction and an oblique direction, and a thick arrow indicates a moving direction of the front panel 200.

The method for controlling the front panel 200 includes: controlling a movement of the front panel and adjusting a spatial position of the front panel 200 to control an air intake volume of the air outlet channel 310. The step specifically includes follows.

Step S10, the front panel 200 moves back and forth relative to the front surface 101, and a spatial size of the air outlet channel 310 is adjusted to control the air intake volume of the air outlet channel 310. The spatial size and the air intake volume of the air outlet channel 310 have the same variation trend.

Step S20, the front panel 200 moves up and down relative to the front face 101, and an opening size of the first air outlet 110 is adjusted to control the air intake volume of the air outlet channel 310. The opening size and the air intake volume of the air outlet channel have reverse variation trends.

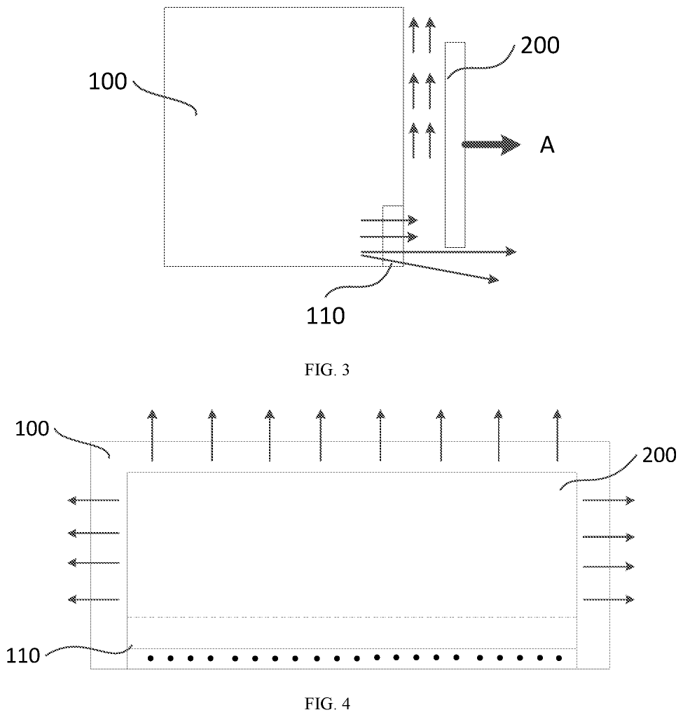

Specifically, in step S10, referring to FIG. 1 to FIG. 4, the front panel 200 moves forward and backward relative to the front end surface 101, that is, the front panel 200 can moves forward along the direction A from a contact state of FIG. 1, and gradually forms the air outlet channel 310 as shown in FIG. 2 and FIG. 3. A spatial size of the air channel 310 is adjusted to control the air intake volume of an air channel, and a volume of the air blown from the first air outlet 110 into the air outlet channel 310 is determined by the size of the air channel, so as to adjust a volume of the air blown out of the second air outlet 320. Moreover, the spatial size and the air intake volume of the air outlet channel 310 have the same variation trend. The larger the spatial size of the air outlet channel 310, the more air is blown into the air outlet channel 310 by the first air outlet 110, and the more air is blown out of the second air outlet 320. Especially, under the premise that a volume of the air generated by the air conditioner is constant or slightly changed, a system resistance formed by the front panel 200 hinders the volume of the air blown out of the first air outlet 110.

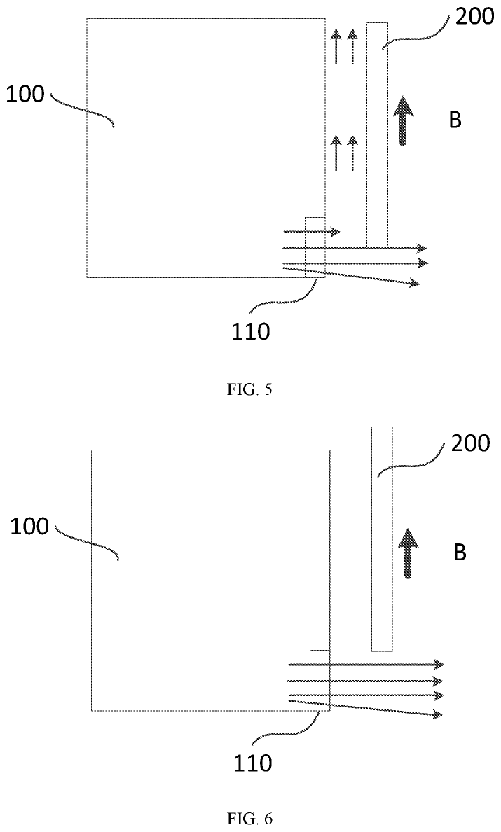

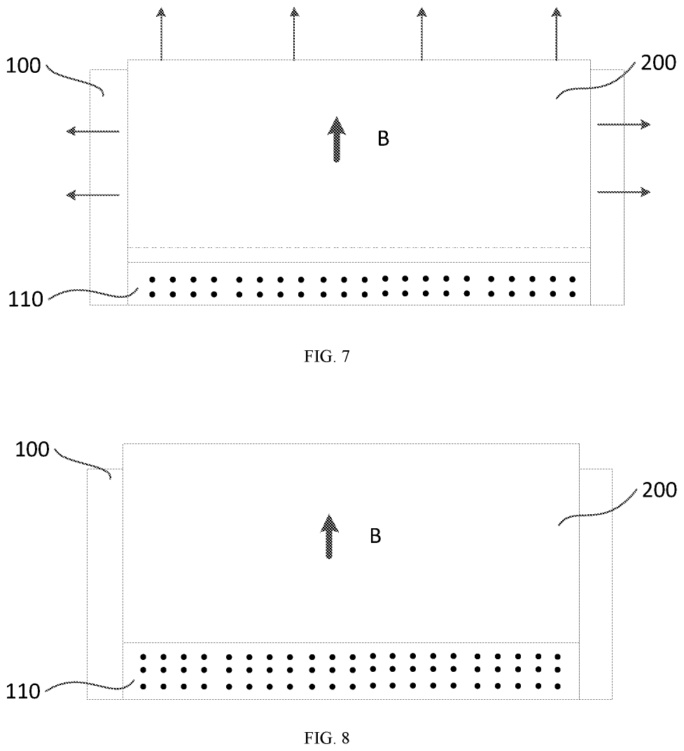

Similarly, in step S20, referring to FIG. 5 to FIG. 8, the front panel 200 moves up and down relative to the front end surface 101. Preferably, when the front panel 200 moves to the farthest position from the front end surface 101, the front panel 200 is lifted along the direction B and the first air outlet 110 is gradually leaked in a horizontal direction, that is, the opening size of the first air outlet 110 is adjusted, so that more air output from the first air outlet 110 can be directly blown forward without being blocked by the front panel 200. Referring to FIG. 5 and FIG. 7, when the front panel 200 is ascended higher and higher, a blocking surface of the front panel 200 becomes smaller and smaller, and less and less air is blown from the first air outlet 110 into the air outlet passage 310, so that less and less air is blown from the second air outlet 320, until the front panel 200 moves to the highest position as shown in FIG. 6 and FIG. 8, the first air outlet 110 is fully completely exposed in the horizontal direction. All the air blown out of the first air outlet 110 is blown forward. In this case, the air conditioner is equivalent to a conventional air conditioner without the front panel 200, and the air blown out of the first air outlet 110 of the air conditioner is guided by the air deflector to achieve an up-and-down sweeping. The array points are indicative air to be blown out.

In this embodiment, referring to FIG. 4, the second air outlet 320 is an annular air outlet or a partial annular air outlet of the front panel 200. The air from the first air outlet 110 is blocked by the front panel 200 to enter the air outlet channel 310, and then the air is blown out of the second air outlet 320. The annular air outlet can discharge air from an upper part, a lower part, a left part and a right part thereof. However, since an air suction structure or other particular structure located at the upper part of the air conditioner, only left and right air outlets or only left and right air outlets can be formed, i.e., partial annular air outlets.

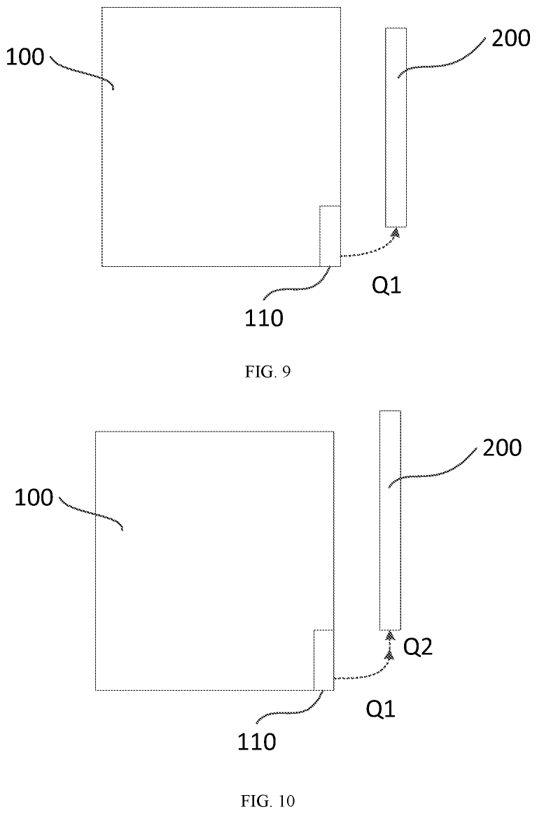

As shown in FIGS. 9 to 12, a first motion trajectory and a second motion trajectory are provided according to a preferred embodiment of the present disclosure.

The method for controlling the front panel 200 further includes: configuring a first motion trajectory Q1 and a second motion trajectory Q2. The first motion trajectory Q1 is a motion trajectory of the front panel 200 moving back and forth relative to the front end surface 101, and the second motion trajectory Q2 is a motion trajectory of the front panel 200 moving up and down relative to the front end surface 101. Specifically, the front panel 200 can move according to a preset motion trajectory through a driving structure. For example, the first motion trajectory Q1 is performed first, and then the second motion trajectory Q2 is performed. Certainly, the front panel 200 may only move back and forth in the first motion trajectory Q1 or the second motion trajectory Q2. Alternatively, the front panel 200 may move back and forth in all or part of the first motion trajectory Q1 and the second motion trajectory Q2. Alternatively, only one motion is performed, and no reciprocating motion is performed. Preferably, the first motion trajectory Q1 is an arc-shaped motion trajectory in a front-up direction. Certainly, the first motion trajectory Q1 may also be an oblique forward motion trajectory or a horizontal forward motion trajectory. More preferably, the front panel 200 can move moves forward first and then moved upward in an arc-shaped or straight-line according to the first motion trajectory Q1, and then the second motion trajectory Q2 is performed.

The moving of the front panel 200 according to the first motion trajectory includes: moving the front panel 200 back and forth, away from or adjacent to the front end surface 101, alternatively, ascending or descending the front panel 200 during moving the front panel 200 back and forth, so as to increase or decrease the opening size of the first air outlet 110. Moreover, when the front panel 200 moves from the horizontal direction along an arc motion trajectory or a linear motion trajectory to the farthest position from the front end surface 101 or to a starting point of the second motion trajectory Q2, the front panel 200 continues to move along the second motion trajectory Q2, so that the front panel 200 moves forward and backward relative to the front end surface 101 and moves up and down relative to the front end surface 101. Certainly, when the front panel 200 moves up and down relative to the front end surface 101, the front panel 200 may not move in a vertical direction, and there may be deviation in other directions.

Further, the opening size of the first air outlet 110 is not the maximum opening size when the front panel 200 is located at the farthest stroke of the arc motion trajectory, and the opening size of the first air outlet 110 is the maximum opening size when the front panel 200 is located at the highest stroke of the second motion trajectory Q2.

As shown in FIG. 1 and FIG. 9 to FIG. 12, the present disclosure provides a preferred embodiment of the front panel in various state according to the front panel control method.

The method for controlling the front panel 200 further includes follows.

A closed state, a forward and backward movement state, and an up and down movement state are configured. The closed state is a state that the front panel 200 is adjacent to the front end surface 101 and closes or semi-closes the first air outlet 110 or a front end of the first air outlet 110. The forward and backward movement state is a process that the front panel 200 moves back and forth relative to the front end surface 101. The up and down movement state is a process that the front panel 200 moves up and down relative to the front end surface 101. The front panel 200 is controlled to be switched between the closed state and the forward and backward movement state, or the front panel 200 is controlled to be switched between the forward and backward movement state and the up and down movement state.

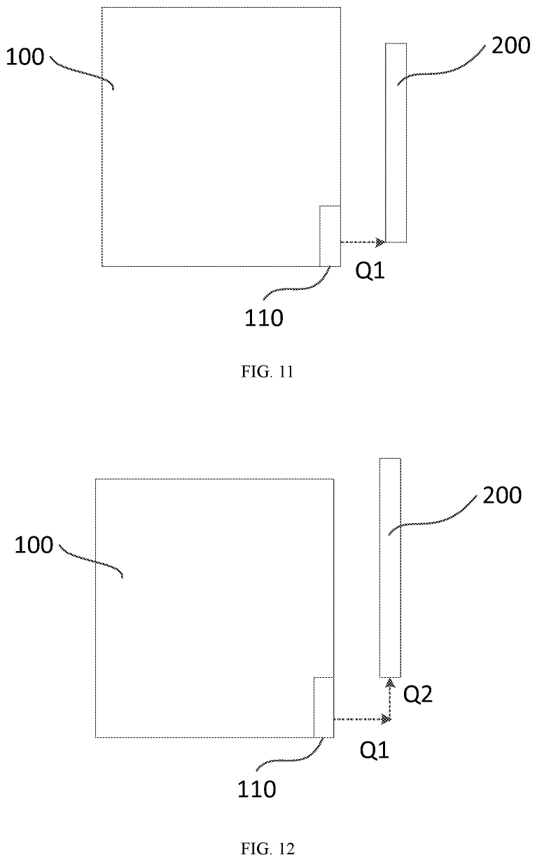

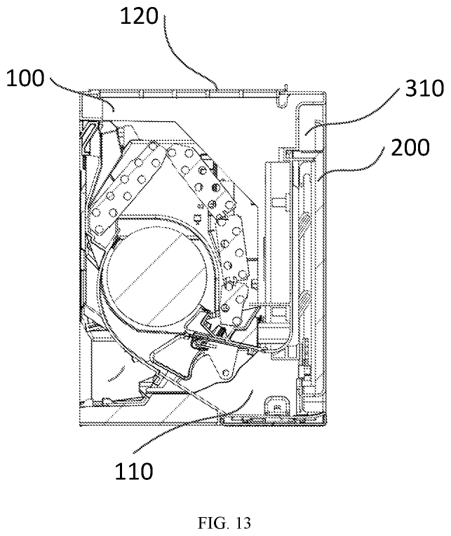

As shown in FIG. 1 and FIG. 11, in the closed state, the front panel 200 is arranged adjacent to the front end surface 101, and the front panel 200 completely close or semi-close the first air outlet 110. Alternatively, the front panel 200 completely blocks the front end of the first air outlet 110, and the front panel 200 may cooperate with the air deflector to achieve a full closure of the first air outlet 110, or the front panel 200 may cooperate with a movable switch door to achieve a full closure of the first air outlet 110. In the forward and backward movement state, the front panel 200 is arranged away from the front end surface 101, and an air outlet duct is formed between the front panel 200 and the front end surface 101. Since the front panel 200 moves according to the arc motion trajectory, the front panel 200 also moves upward when front panel 200 moves away from the front end surface 101. Part of the air blown out of the first air outlet 110 is directly blown out horizontally, and part of the air enters the air outlet duct duo to the blocking of the front panel 200. Alternatively, the front panel 200 moves according to a forward linear motion trajectory, and the front panel 200 only moves forward in the process of moving away. Alternatively, the front panel 200 moves according to a particular motion trajectory, and the front panel 200 moves forward and then moves in an arc shape in the process of moving away. Alternatively, the front panel 200 moves according to a particular motion trajectory, and the front panel 200 moves forward and then moves obliquely in a forward and upward direction in the process of moving away. As shown in FIG. 10 and FIG. 13, in the up and down movement state, the front panel 200 can be ascended or descended to adjust the opening size of the first air outlet 110, that is, the opening size of the first air outlet 110 blocked in the horizontal direction and the air blown out of the first air outlet 110 is controlled by the ascending or descending of the front panel 200. Further, an air inlet is provided at the top of the middle frame 100 of the air conditioner, and air is sucked by the air inlet and blown out of the first air outlet 110 through being adjusted by the internal structure.

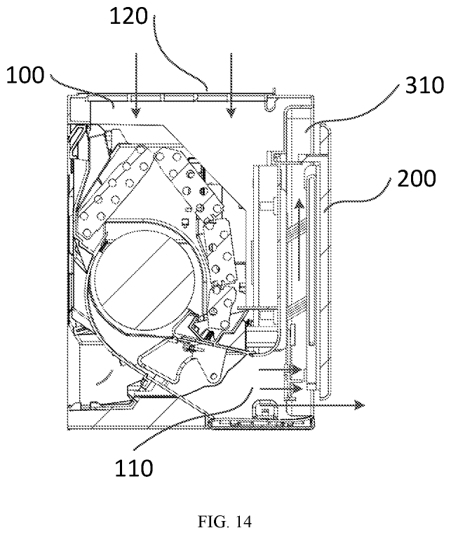

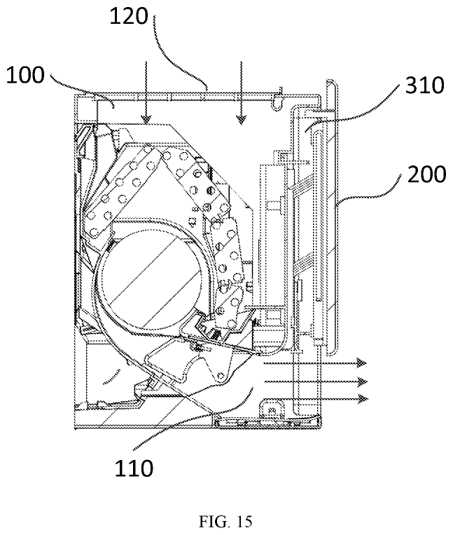

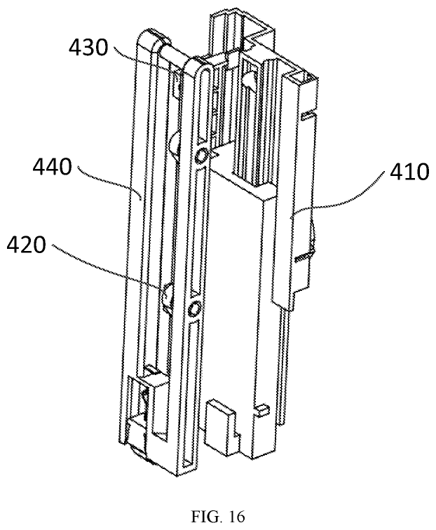

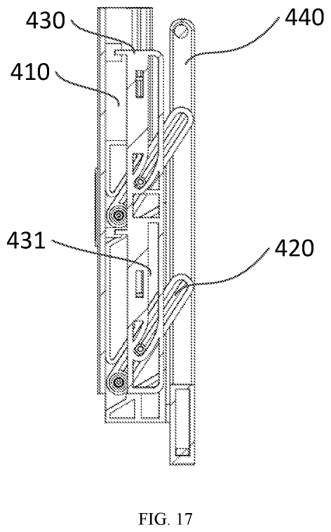

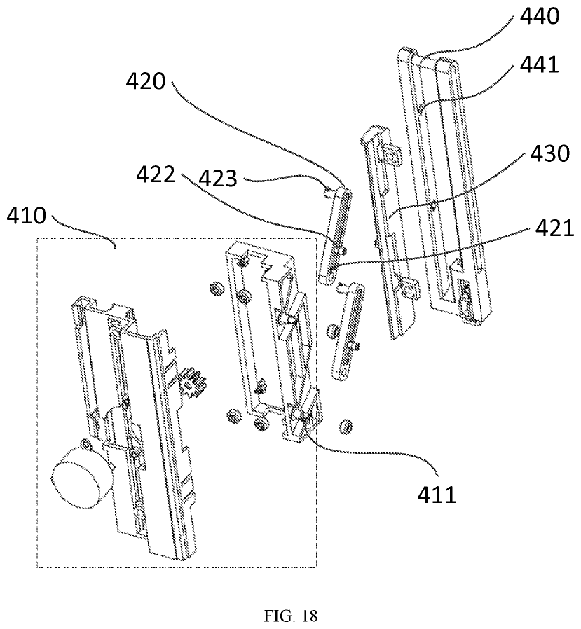

As shown in FIG. 11 and FIG. 14 to FIG. 18, the present disclosure provides a preferred embodiment of a front panel device of an air conditioner.

A front panel device of an air conditioner includes a middle frame 100, a first air outlet 110 provided on the front end surface 101 of the middle frame, a front panel 200 movably provided on the front end surface 101, and a driving mechanism 400 provided between the front end surface 101 and the front panel 200. The driving mechanism 400 is fixed on the front end surface 101 and is configured to drive the front panel 200 to move according to the method for controlling the front panel 200.

In this embodiment, the driving mechanism 400 includes a lifting structure 410, a connecting rod 420, and a track structure 430. One end of the connecting rod 420 is connected to the lifting structure 410, a middle portion of the connecting rod 420 is slidably connected to a track 431 of the track structure 430, and the other end of the connecting rod 420 is connected to the front panel 200. The lifting structure 410 is connected to the front end surface 101. The driving mechanism 400 may further include a support frame 440. The connecting rod 420 is connected to the front panel 200 through the support frame 440. The connecting rod 420 is driven by the lifting structure 410 to drive the support frame 440 and the front panel 200 to move along a trajectory of the track 431. The track 431 of the track structure 430 is upper vertical lower curved arc shape, or a polyline shape, so that that front panel 200 can be move back and forth along with a rising motion.

The specific connection relationship is that the lifting structure 410 drives an end of the connecting rod 420 to ascend, thereby driving the whole connecting rod 420 to ascend. A corresponding limiting structure is provided to limit the connecting rod 420, so as to drive the whole connecting rod 420 to ascend, and an upper connecting rod 420 and a lower connecting rod 420 are provided to improve a stability of the movement of the support frame 440. The connecting rod 420 is provided with a through hole 421 and cooperates with a rotating shaft 411 on the lifting structure 410. Furthermore, the track structure 430 is provided with the track 431, and the middle portion of the connecting rod 420 is provided with a protrusion 422, which cooperates with the track, so as to control a motion trajectory of the connecting rod 420, that is, the connecting rod 420 is driven by the lifting structure 410 to move back and forth. The middle portion of the connecting rod 420 refers to other positions except the two ends. The other end of the connecting rod 420 is also provided with a protrusion 423, which is cooperatively received in a through hole 441 of the supporting frame 440, so that the connecting rod 420 drives the supporting frame 440 to move, such as forward and backward movement, lifting movement, etc.

The front panel 200 moves back and forth relative to the front face 101 and the front panel 200 moves up and down relative to the front face 101 by the track 431 and driving of the lifting structure 410.

The above description is only the preferred embodiment of the present disclosure, and is not intended to limit the scope of the present disclosure. All equivalent changes or modifications made in accordance with the scope of the present disclosure may be covered by the present disclosure.

1. A method for controlling a front panel of an air conditioner, wherein a front end surface of the air conditioner is provided with a first air outlet, the front panel is movably arranged on the front end surface, the front panel and the front end surface form an air outlet channel in communication with the first air outlet when the front panel moves back and forth relative to the front end surface, and the air outlet channel forms at least one second air outlet at a peripheral edge of the front panel, wherein the method for controlling the front panel of the air conditioner comprises:
controlling a movement of the front panel and adjusting a spatial position of the front panel to control an air intake volume of the air outlet channel.

2. The method for controlling the front panel according to claim 1, wherein the step of controlling the movement of the front panel and adjusting the spatial position of the front panel comprises: moving the front panel back and forth relative to the front end surface, and adjusting a spatial size of the air outlet channel to control the air intake volume of the air outlet channel, wherein the spatial size and the air intake volume of the air outlet channel have the same variation trend.

3. The method for controlling the front panel according to claim 1, wherein the step of controlling the movement of the front panel and adjusting the spatial position of the front panel comprises: moving the front panel moves up and down relative to the front end surface, and adjusting an opening size of the first air outlet to control the air intake volume of the air outlet channel, wherein the opening size and the air intake volume of the air outlet channel have reverse variation trends.

4. The method for controlling the front panel according to claim 1, further comprising:
configuring a first motion trajectory and a second motion trajectory, the first motion trajectory being a motion trajectory of the front panel moving back and forth relative to the front end surface, the second motion trajectory being a motion trajectory of the front panel moving up and down relative to the front end surface;
wherein the front panel moves on the front end surface according to the first motion trajectory and the second motion trajectory.

5. The method for controlling the front panel according to claim 4, wherein the first motion trajectory is an arc-shaped motion trajectory in a front-up direction, an oblique forward motion trajectory, or a horizontal forward motion trajectory.

6. The method for controlling the front panel according to claim 4, wherein the moving the front panel according to the first motion trajectory comprises:
moving the front panel back and forth, away from or adjacent to the front end surface.

7. The method for controlling the front panel according to claim 4, wherein the opening size of the first air outlet is not the maximum opening size when the front panel is located at the farthest stroke of the first motion trajectory, and the opening size of the first air outlet is the maximum opening size when the front panel is located at the highest stroke of the second motion trajectory.

8. The method for controlling the front panel according to claim 1, further comprising:
configuring a closed state, a forward and backward movement state, and an up and down movement state; wherein the closed state is a state that the front panel is adjacent to the front end surface and closes or semi-closes the first air outlet or a front end of the first air outlet, the forward and backward movement state is a process that the front panel moves forward and backward relative to the front end surface, and the up and down movement state is a process that the front panel moves up and down relative to the front end surface; and
controlling the front panel to be switched between the closed state and the forward and backward movement state, or controlling the front panel to be switched between the forward and backward movement state and the up and down movement state.

9. The method for controlling the front panel according to claim 1, wherein the second air outlet is an annular air outlet or a partial annular air outlet of the front panel, and air from the first air outlet is blocked by the front panel to enter the air outlet channel and is blown out of the second air outlet.

10. A front panel device of an air conditioner, comprising:
an air conditioner body;
a first air outlet provided on a front end surface of the air conditioner body;
a front panel movably provided on the front end surface; and
a driving mechanism provided between the front end surface and the front panel, wherein the driving mechanism is fixed on the front end surface and is configured to drive the front panel to move according to a method for controlling the front panel according to claim 1.

11. The front panel device according to claim 10, wherein the driving mechanism comprises a lifting structure, a connecting rod, and a track structure, one end of the connecting rod is connected to the lifting structure, a middle portion of the connecting rod is slidably connected to a track of the track structure, the other end of the connecting rod is connected to the front panel or is connected to the front panel through an intermediate element, the lifting structure is connected to the front end surface, and the connecting rod is driven by the lifting structure to drive the front panel to move along a trajectory of the track.

12. The front panel device according to claim 11, wherein the track of the track structure is in a shape of a polyline.

13. The method for controlling the front panel according to claim 6, wherein the moving the front panel according to the first motion trajectory further comprises:
ascending or descending the front panel during moving the front panel back and forth, so as to increase or decrease the opening size of the first air outlet.
